(19) United States
(12) Patent Application Publication
(10) Pub. No.: US 2011/0153411 A1
(43) Pub. Date: Jun. 23, 2011

(54) METHOD AND SYSTEM FOR IDENTIFICATION OF AN ONLINE PURCHASE WITHOUT NOTIFICATION OF MAKING THE PURCHASE

(75) Inventors: Roei Levav, New York, NY (US); Tzach Zohar, Tel Aviv (IL); Nir Cohen, Rishon Lezion (IL)

(73) Assignee: KENSHOO LTD., Tel Aviv (IL)

(21) Appl. No.: 12/977,373

(22) Filed: Dec. 23, 2010

Related U.S. Application Data
(60) Provisional application No. 61/289,410, filed on Dec. 23, 2009.

(51) Int. Cl. G06Q 30/00

(52) U.S. Cl. 705/14.41

(57) ABSTRACT

A system and method for identification of an on-line purchase by tracking on-line advertisement interaction. The method comprises comparing between at least one cookie value generated by a tracking server and at least one cookie value provided by one or more web servers, wherein the comparison results in a list of matching cookies; matching between a plurality of on-line purchase transactions and a plurality of on-line advertisements that a user interacted with, wherein the matching is based, in part, on the list of matching cookies and click identifications; and generating, based on the matching results, a report including conventions of the user interaction with the plurality of on-line advertisements into one or more on-line purchases made by the user.

### CROSS REFERENCE TO RELATED APPLICATIONS

The present invention claims the benefit of U.S. provisional patent application No. 61/289,410, entitled “A Method and System for Identification of an Online Purchase without Notification of Making the Purchase”, filed Dec. 23, 2009, the contents of which are herein incorporated by reference.

### TECHNICAL FIELD

The invention generally relates to electronic commerce, and more particularly to the association of a commerce transaction with one or more clicks on the path that lead to the transaction.

### BACKGROUND OF THE INVENTION

The Internet and the worldwide web (WWW) became within a short period of time a popular vehicle for doing business. Transactions are simple, accessible worldwide and are reliable enough to continuously move purchasers from the old way of doing business by appearing in person at a store, to an environment where the purchase is performed using a mere of web accessible devices such as personal computers (PCs), personal digital assistants (PDAs), mobile phones, smartphones, tablet computers, and the like.

The Internet also changes significantly the way advertising media operates and the ability to track success thereof. An advertiser in the “old environment” would have had little knowledge as to the path from seeing the impact of an advertisement which leads to the actual purchase by a user. By contrast, as the technology of electronic commerce developed, such tracking of commerce has become a possibility and can provide advantages when appropriately applied.

Tracking solutions have been proposed in prior art solutions. However, such solutions do require the establishment of a full closed loop from the click on the advertisement (e.g., clicking on a hyperlink embedded in an on-line advertisement banner) to the point of purchase to ensure that the purchase is attributed to a specific advertisement.

It would be therefore advantageous to provide a solution that enables tracking of such clicks without an in-place closed loop. It would be further advantageous if the solution tracks purchases associated with a click even when a full path does not exist between the click and the actual purchase.

### SUMMARY OF THE INVENTION

Certain embodiments of the invention include a system for identifying an on-line purchase by tracking advertisement interaction. The system comprises at least one user node connected to a network and equipped with at least a web browser; at least one web server connected to the network for displaying of a web page including an on-line advertisement on a display of the at least one user node responsive to a request from the user node and for retrieving from the at least one user node a cookie value, wherein the cookie value uniquely identifies a user of the at least one user node with respect to an on-line advertisement; an advertisement server connected to the network for providing the on-line advertisement to the at least one web server and generating a click identification responsive of a click of the user of the at least one user node on the on-line advertisement; and a tracking server connected to the network for associating a plurality of on-line purchase transactions with an interaction of the user of the at least one use node with on-line advertisement based, in part, on the cookie value and the click identification.

Certain embodiments of the invention also include a tracking server for identifying an on-line purchase by tracking on-line advertisement interaction. The tracking server comprises an interface to a network, the network is connected to at least one user node, at least one web server, and at least one advertisement server; and a computing module that responds to a click on an on-line advertisement supplied by the at least one advertisement server to the web server for display as part of a web page on the display of the at least one user node, the tracking server receives a cookie value and a click identification for association of a plurality of on-line purchase transactions with an interaction of a user of the at least one user node with the on-line advertisement displayed on the at least one user node's display.

Certain embodiments of the invention further include a method for identification of an on-line purchase by tracking on-line advertisement interaction. The method comprises comparing between at least one cookie value generated by a tracking server and at least one cookie value provided by one or more web servers, wherein the comparison results in a list of matching cookies; matching between a plurality of on-line purchase transactions and a plurality of on-line advertisements that a user interacted with, wherein the matching is based, in part, on the list of matching cookies and click identifications; and generating, based on the matching results, a report including conventions of the user interaction with the plurality of on-line advertisements into one or more on-line purchases made by the user.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a system for displaying advertisements, tracking clicks and conversions to purchases in accordance with the certain embodiments of the invention;

FIG. 2 is a diagram of a data flow in accordance with the certain embodiments of the invention;

FIG. 3 is a flowchart of click tracking from a user node side;

FIG. 4 is a flowchart of click tracking from a web site side; and

FIG. 5 is a flowchart of report generation by a tracking server.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In some cases, it is not practical or impossible to generate a notification of a making of a purchase on-line to a system attempting to track the value of keywords and/or advertisements leading to such a purchase. Certain embodiments of the invention provide a system and method for tracking the use of the keywords and/or advertisements, and then comparing tracking results to an electronic report on actual purchases made. Based on parameters respective of the path to purchase of a user and certain purchase data, a match is found.

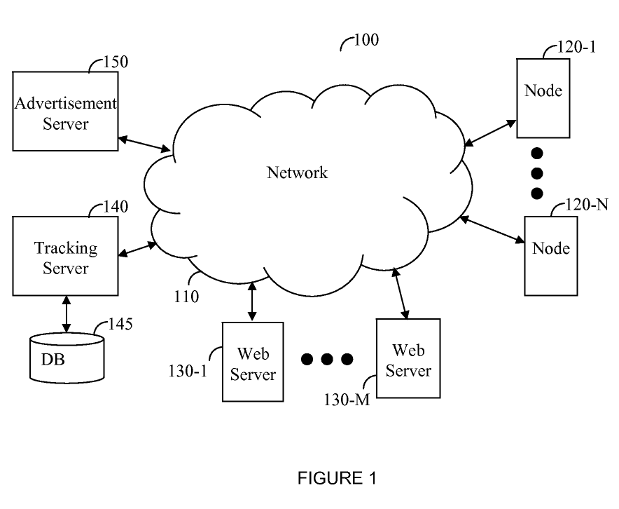

FIG. 1 depicts an exemplary and non-limiting system 100 for displaying advertisements, tracking clicks and conversions to purchases in accordance with certain embodiments of the invention. The system comprises a network 110 to which a plurality of user nodes 120-1 through 120-N are communicatively connected. The network may be, but is not limited to, a local area network (LAN), a metro area network (MAN), a wide area network (WAN), Internet, worldwide web (WWW), and the like. To the network 110 there are also communicatively connected a plurality of web servers 130-1 through 130-M, each web server, for example web server 130-1, capable of providing a user node, for example user node 120-1, a web page. Web pages provided by a web server may further contain advertisements, either tailored or otherwise integrated into the web pages, and typically supplied from a source for advertisements, for example, an advertisement server 150.

According to an embodiment of the invention, when an advertisement is clicked by a user of, e.g., the user node 120-1, a cookie is transferred to the browser used by the node 120-1 providing a unique identification of the user of the user node 120-1 with respect to a particular advertisement or advertisement campaign. The user is then transferred to a web server, e.g., web server 130-1 that provides access to a web server that is the landing page for the advertisement, for example, on web server 130-M. The cookie value is now accessible to both the landing web server 130-M as well as the user node 120-1. Upon completion of a desired transaction, the landing web server provides the cookie value together with other tracking information to a tracking server 140 which is also communicatively connected to the network 110. When a user of the user node 120-1 achieves a transaction with respect to an advertisement, regardless of how the user reached that advertisement, the user can be identified by means of reports provided from both the user node 120-1 and the landing web site 130-M, and further by matching the reports identifying the advertisement(s) that lead to the conversion into a purchase. In an embodiment of the invention, the advertisement server 150 is, but not limited to, a search engine.

In another embodiment of the invention, a click on an advertisement is passed through a redirect server (not shown) that in one embodiment may be part of the tracking server 140. The redirect server generates URL parameters and feeds the tracking system of the tracking server 140 with these parameters. A more detailed description is provided herein below.

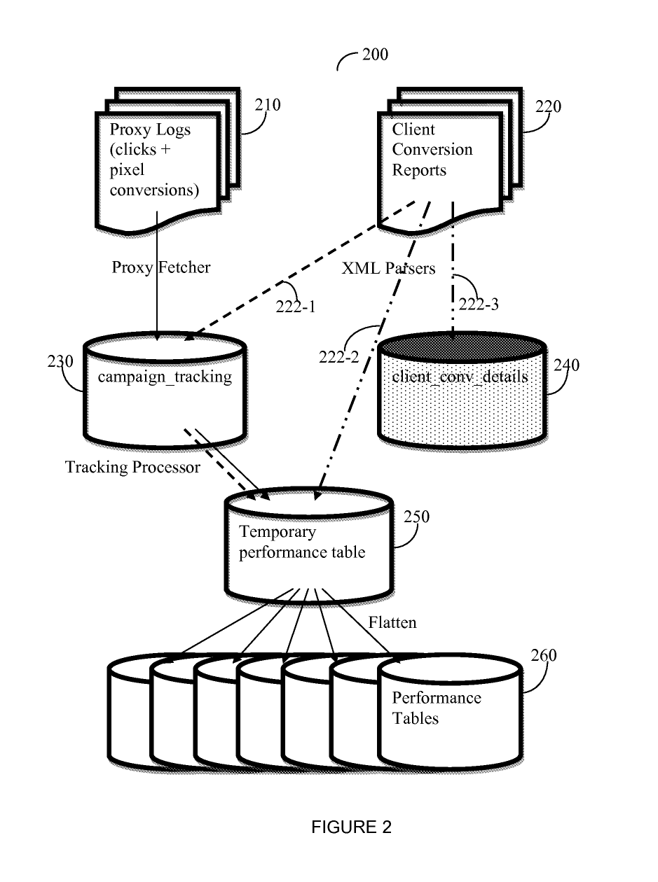

FIG. 2 shows a diagram of the data flow in accordance with an embodiment of the invention. Proxy logs 210 are sent from a user node 120 to the tracking server 140. Client conversion reports, containing information respective of a conversion of a connection into a transaction, e.g., sale, are provided from a web server 130 to the tracking server 140. The reports are parsed by, for example, XML passers 222-1, 222-2, and 222-3 for the purpose of storage in repositories 230 and 240. In repository 230 it is possible to track the advertisement campaign as multiple advertisements may lead to a user conversion and it is important to understand which of the advertisements, not only the one that lead to a purchase, but also those viewed prior thereto, are tracked. The tracking server 140 generates one or more temporary performance tables 250 that are then flattened into a plurality of performance tables 260, enabling the tracking of a single campaign, containing a plurality of advertisements, or a single advertisement as the case may be. The performance tables 250 and 260 are saved in a database 145 (see FIG. 1) that may be connected or be part of the tracking server 140. The repositories 230 and 240 as well as database 145 may be any tangible readable medium for storing digital data.

Basically, the process used herein entails adding a wildcard to the URL of the advertisement that is replaced by the advertisement server 150 with the cookie value. The XML parsers 222 check for the existence of the cookie values in client conversion reports 220 and create tracking observations. The tracking server 140 saves in its database 145 the last processed click time as a member and updates each processed click if accessed before clicks were processed. Hence, according to an embodiment of the invention, a cookie value in the URL is used, which is then received from node (e.g., user node 120-1) thereafter being reported in the report, and then the conversion is detected according to the cookie value. A de-duplication process may take place to avoid unnecessary duplications.

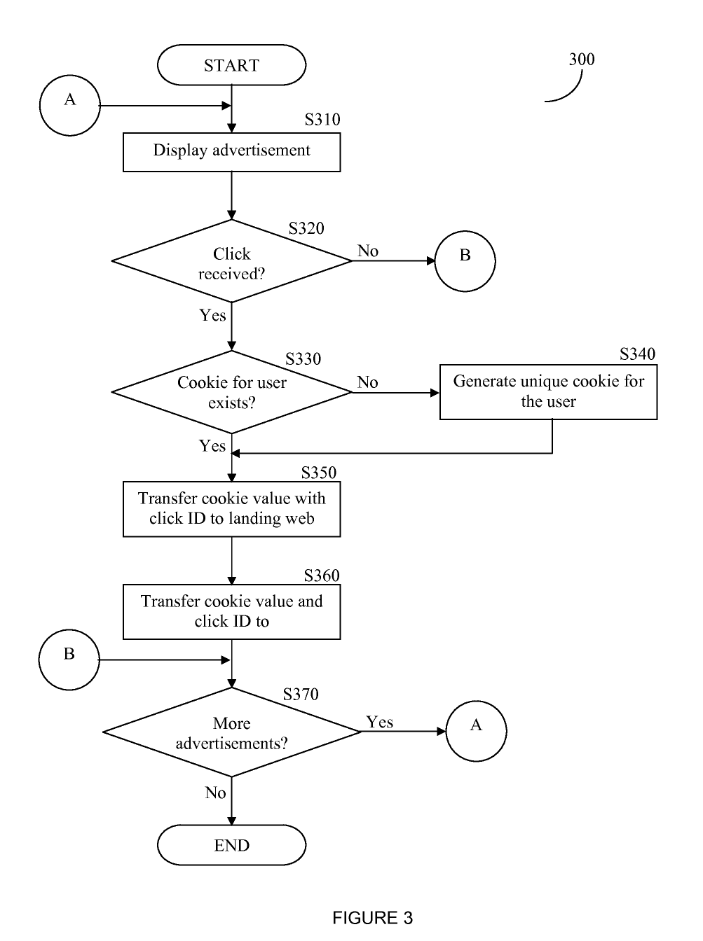

FIG. 3 depicts an exemplary and non-limiting flowchart 300 of click tracking by a user node. In S310, an advertisement is displayed on the browser of the user node, for example, user node 120-1. In S320, it is checked whether a click was received, and if so execution continues with S330; otherwise, execution continues with S370. In S330, it is checked whether a cookie value for the user accessing the advertisement that was clicked was already provided, and if not execution continues with S340 where a unique cookie for the user is generated; otherwise, execution continues with S350.

In S350, the cookie value and the click ID are transferred as a URL parameter to the landing server, for example, one of web servers 130-1 through 130-M shown in FIG. 1. In S360, the cookie value and click ID are also transferred to the tracking server, for example, the tracking server 140. The information of the user node and the advertisement clicked upon is now available for tracking purposes and the preparation of reports by, for example, the tracking server. This also allows identifying a conversion of a click on an advertisement to an actual on-line purchase, even if the purchase is immediately not performed when accessing the advertisement in the landing web server, but also if a user of a user node reaches a conversion in a subsequent access using a different advertisement that belongs to the same campaign. In S370, it is checked whether additional advertisements are to be checked, and if so, execution continues with S310; otherwise, execution terminates. It should be noted that while advertisements are discussed hereinabove, and elsewhere in the description of the invention, this would be equally applicable to, for example, and without limitations, keywords.

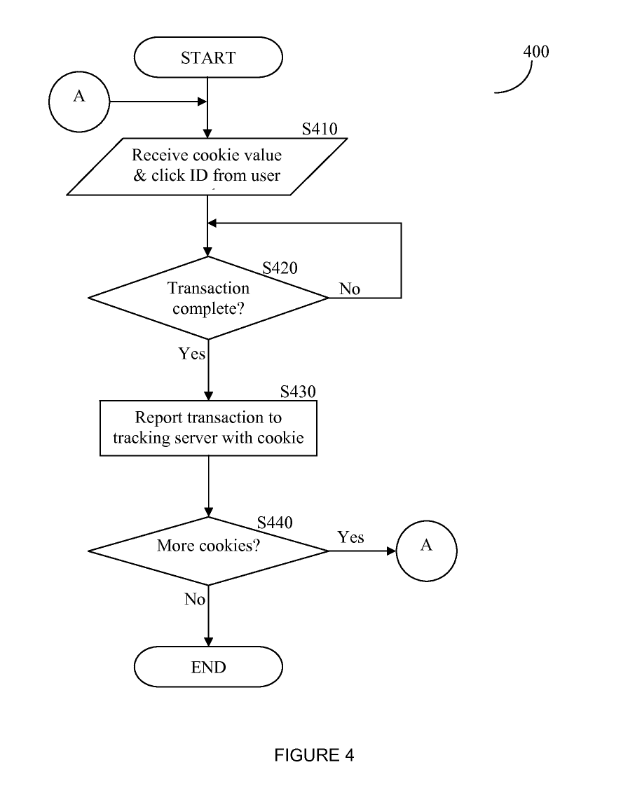

FIG. 4 depicts an exemplary and non-limiting flowchart 400 of click tracking as performed in a web server, for example, web server 130-1. In S410, a cookie value and click ID is received from a user node, for example, the user node 120-1. In S420, it is checked if a transaction has completed, and if so execution continues with S430; otherwise, execution continues with S420. A completed transaction may be an actual purchase, but may also be just a review of the advertisement without a conversion to an actual purchase. In S430, a report about the specific transaction occurring with respect of the displayed advertisement is sent to the tracking server, for example, tracking server 140, including transaction details. In S440, it is checked whether additional cookie values and click IDs are to be received and if so, execution continues with S410; otherwise, execution terminates.

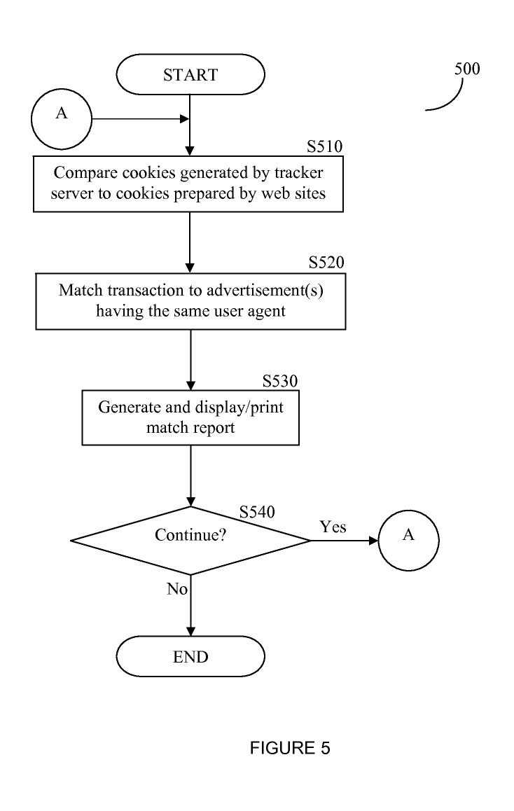

FIG. 5 depicts an exemplary and non-limiting flowchart 500 of report generation by the tracking server, for example, the server 140. In S510, a comparison takes place between cookie values generated by the tracking server, for example server 140, to cookie values provided to the tracking server by one or more of the web servers, for example, servers 130, resulting in a list of cases of matching cookies. In S520, matching between the transactions and the advertisements takes place based on the matching of cookie values and click indemnifications. That is, one or more advertisements may be matched to the same user node (e.g., user node 120-1) manifested by the cookie value. This results in the matching of a successful transaction with the user who made it in an explicit manner, thereby enabling tracking of such transactions. It should be appreciated that by performing these comparisons (S510 and S520), it further is possible to identify the advertisements that were key to leading a user of a user node to convert such access into an actual purchase or other desirable and traceable result.

In S530, a report is generated for display, distribution, storage, or printout, as the case may be. As mentioned above a report may include association of user interaction with an advertisement or advertisements of a campaign with and actual online purchases made by the user. In S540, it is checked whether additional reports are to be generated, and if so execution continues with S510; otherwise, execution terminates.

It should be appreciated that while hereinabove the reference was to advertisement, the embodiments shown herein are adaptable to use with keywords, hence allowing the identification of keywords that lead to the tracking of desirable conversions. A person with ordinary skill in the art should further appreciate that it would not be necessary to change the source code of the web page on the landing web site server 130, and hence advantageous for the users thereof.

Hence, according to certain embodiments of the invention instead of sending keywords or advertisement identifications, cookie identification is used for the user. This enables the system to associate a conversion, in its broadest definition, with preceding clicks instead of association with a keyword or an advertisement. The invention therefore enables to detect later activities that occur inside of the client's web site.

The principles of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers may be combined into one or more integrated servers.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A system for identifying of an on-line purchase by tracking advertisement interaction, comprising:
at least one user node connected to a network and equipped with at least a web browser;
at least one web server connected to the network for displaying of a web page including an on-line advertisement on a display of the at least one user node responsive to a request from the user node and for retrieving from the at least one user node a cookie value, wherein the cookie value uniquely identifies a user of the at least one user node with respect to an on-line advertisement;
an advertisement server connected to the network for providing the on-line advertisement to the at least one web server and generating a click identification responsive of a click of the user of the at least one user node on the on-line advertisement; and
a tracking server connected to the network for associating a plurality of on-line purchase transactions with an interaction of the user of the at least one use node with on-line advertisement based, in part, on the cookie value and the click identification.

2. The system of claim 1, wherein the advertisement is a keyword.

3. The system of claim 1, further comprising a database connected to the tracking server for storing information respective of the on-line advertisement and the click identification.

4. The system of claim 1, wherein the tracking server generates a report with respect of the plurality of on-line purchase transactions and respective click identifications.

5. The system of claim 4, wherein the report is stored in storage by the tracking server.

6. The system of claim 4, wherein the report is displayed by the tracking server on a display device.

7. The system of claim 4, wherein the report is delivered electronically by the tracking server to a user of the at least one user node.

8. The system of claim 1, wherein the tracking server further comprises a redirect server for generating a universal resource locator (URL) parameter responsive of receiving the cookie value and the click identification.

9. A tracking server for identifying an on-line purchase by tracking on-line advertisement interaction, comprising:
an interface to a network, the network is connected to at least one user node, at least one web server, and at least one advertisement server; and
a computing module that responds to a click on an on-line advertisement supplied by the at least one advertisement server to the web server for display as part of a web page on the display of the at least one user node, the tracking server receives a cookie value and a click identification for association of a plurality of on-line purchase transactions with an interaction of a user of the at least one user node with the on-line advertisement displayed on the at least one user node's display.

10. The tracking server of claim 9, further comprising a database connected to the tracking server for storing information respective of the on-line advertisement and the click identification.

11. The tracking server of claim 10, wherein the tracking server generates a report with respect of the on-line purchase transactions and respective click identifications.

12. The tracking server of claim 11, wherein the report is stored in storage by the tracking server.

13. The tracking server of claim 11, wherein the report is displayed by the tracking server on a display device.

14. The tracking server of claim 11, wherein the report is delivered electronically by the tracking server to a user of the at least one user node.

15. The tracking server of claim 9, further comprising:
a redirect server for generating a universal resource locator (URL) parameter responsive of receiving the cookie value and the click identifier.

16. A method for identification of an on-line purchase by tracking on-line advertisement interaction, comprising:
comparing between at least one cookie value generated by a tracking server and at least one cookie value provided by one or more web servers, wherein the comparison results in a list of matching cookies;
matching between a plurality of on-line purchase transactions and a plurality of on-line advertisements that a user interacted with, wherein the matching is based, in part, on the list of matching cookies and click identifications; and
generating, based on the matching results, a report including conventions of the user interaction with the plurality of on-line advertisements into one or more on-line purchases made by the user.

17. The method of claim 16, wherein the click identifications provide information about advertisements that the user interacted with, wherein the click identifications are generated by at least one user node.

18. The method of claim 16, further comprising:
storing the generated report, the cookie values and the click identifications in a database.

19. The method of claim 18, further comprising:
displaying the generated report.

20. The method of claim 16, further comprising;
receiving a universal resource locator (URL) parameter including a cookie value and a click identification; and
detecting a convention of a click on an on-line advertisement to an actual on-line purchase based, in part, on the cookie value in the URL.

21. A non-transitory computer readable medium having stored thereon instructions for causing one or more processing units to execute the method according to claim 16.
